(19) United States
(12) Patent Application Publication
(10) Pub. No.: US 2008/0000420 A1
(43) Pub. Date: Jan. 3, 2008

(54) Shadow mask and deposition device having the same

(75) Inventors: Jeong Hyun Kim, Gyeonggi-do (KR); Jae Yoon Lee, Seoul (KR); Sang Keun Lee, Gyeonggi-do (KR)

Correspondence Address: BRINKS HOFER GILSON & LIONE, P.O. BOX 10395, CHICAGO, IL, 60610, US

(73) Assignee: LG PHILIPS LCD CO., LTD.

(21) Appl. No.: 11/823,545

(22) Filed: Jun. 27, 2007

(30) Foreign Application Priority Data
Jun. 30, 2006 (KR) 060122/2006

(51) Int. Cl. B05C 11/11

(52) U.S. Cl. 118/504

(57) ABSTRACT

Disclosed are a shadow mask and a deposition device having the same. The deposition device includes a shadow mask that has a plurality of openings, a chamber that has the shadow mask therein, a deposition cell disposed on a lower portion of the chamber, in which the deposition cell contains deposition materials, and a blocking member interposed between an inner side of the chamber and an outer side of the shadow mask so as to prevent the deposition materials from passing through between the inner side of the chamber and the outer side of the shadow mask. Deposition materials sublimated from a deposition cell are prevented from passing through the shadow mask, except for the openings of the shadow mask, so that the inside of a chamber can be prevented from being contaminated, thereby improving workability of a thin film deposition device. Deposition materials attached to the inside of the chamber can be prevented from being separated from the chamber, so the deposition materials cannot serve as particles.

This application claims the benefit of Korean Patent Application No. 060122/2006, filed Jun. 30, 2006, the entirety of which is hereby incorporated by reference.

### BACKGROUND OF THE INVENTION

1. Field of the Invention

The present invention relates to a shadow mask and a deposition device having the same.

2. Description of the Related Art

Recently, an information processor capable of processing mass storage data in a short time period and a display apparatus capable of displaying data processed by the information processor as an image have been developed.

A display apparatus representatively includes a Liquid Crystal Display (LCD), an Organic Light Emitting Diode (OLED), a Plasma Display Panel (PDP), etc.

Among the above devices, an OLED can operate in low voltage and can be made thin.

Further, an OLED has a wide viewing angle and a quick response speed.

Furthermore, an OLED can display an image having display quality similar to that provided by an LCD or a PDP, and can also be manufactured by a simple process.

In general, an OLED includes a transparent electrode arranged on a transparent substrate, an organic light emitting layer arranged on the transparent electrode, and a metal electrode arranged on the organic light emitting layer.

Among them, an organic light emitting layer has a multi-layer structure including various organic materials. For example, an organic light emitting layer includes organic layers such as hole injection and transfer layers HIL and HTL, an emitting layer EML, electron injection and transfer layers EIL and ETL.

In general, an organic light emitting layer is formed by a vapor deposition method. A related vapor deposition device forming an organic light emitting layer includes a chamber and a shadow mask. In detail, a related vapor deposition device includes a chamber having a cylindrical shape and a shadow mask having a rectangular plate shape and openings. An organic port having deposition materials constituting an organic light emitting layer is arranged in the lower surface of the chamber.

The deposition materials in the organic port are sublimated at sublimation temperature, and the sublimated materials move toward the upper surface of the chamber through the openings of the shadow mask. The deposition materials having passed through the shadow mask are deposited with a predetermined pattern on a substrate arranged on the upper surface of the chamber.

However, the deposition materials sublimated from the organic port of the deposition device for forming the organic light emitting layer are provided to the substrate through a space between the chamber and the shadow mask as well as the openings of the shadow mask. Therefore, the substrate and the inside of the chamber are easily contaminated.

### SUMMARY OF THE INVENTION

An object of the present invention is to provide a shadow mask capable of preventing a chamber and a substrate from being contaminated.

Another object of the present invention is to provide a deposition device having a shadow mask capable of preventing the chamber and the substrate from being contaminated.

To achieve the above object, the present invention provides a shadow mask comprising a mask body having an outer side spaced along an inner side of a chamber by a predetermined interval, and openings formed through the mask body.

To achieve the above object, the present invention provides a deposition device comprising a chamber, a shadow mask dividing the chamber into an upper portion and a lower portion, and having openings through which the upper portion is communicated with the lower portion, a deposition cell arranged on the lower portion of the chamber, in which the deposition cell contains deposition materials, and a supporting member arranged along an inner side of the chamber to support edges of the shadow mask.

### BRIEF DESCRIPTION OF THE DRAWINGS

FIG. 1 is a plan view of a shadow mask according to one embodiment of the present invention;

FIG. 2 is a plan view of a shadow mask according to another embodiment of the present invention;

FIG. 3 is a sectional view of a deposition device according to one embodiment of the present invention;

FIG. 4 is a plan view of the shadow mask shown in FIG. 2 according to further another embodiment of the present invention;

FIG. 5 is a plan view of the shadow mask according to still another embodiment of the present invention;

FIG. 6 is a plan view illustrating the chamber of the deposition device according to another embodiment of the present invention;

FIG. 7 is a plan view illustrating a state in which the shadow mask is coupled to the deposition device in FIG. 6;

FIG. 8 is a plan view illustrating the chamber of the deposition device according to further another embodiment of the present invention; and

FIG. 9 is a plan view illustrating a state in which the shadow mask is coupled to the deposition device in FIG. 8.

### DETAILED DESCRIPTION OF THE INVENTION

Although a shadow mask and a deposition device having the same according to embodiments will be described with reference to accompanying drawings, it should be understood that numerous other modifications and embodiments can be devised by those skilled in the art that will fall within the spirit and scope of the principles of this disclosure. In the accompanying drawings, sizes of a chamber, a deposition cell, a substrate fixing unit, a shadow mask and other structures are enlarged or reduced for the precision of the present invention. In the present invention, when it is described that layers are formed “on”, “on an upper surface” or “on a lower surface”, it means that they are directly or indirectly formed on the upper surface or the lower surface of the chamber, the deposition cell, the substrate fixing unit, the shadow mask and other structures, and other chamber, deposition cell, substrate fixing unit, shadow mask and structures can be additionally formed on a substrate.

Shadow Mask

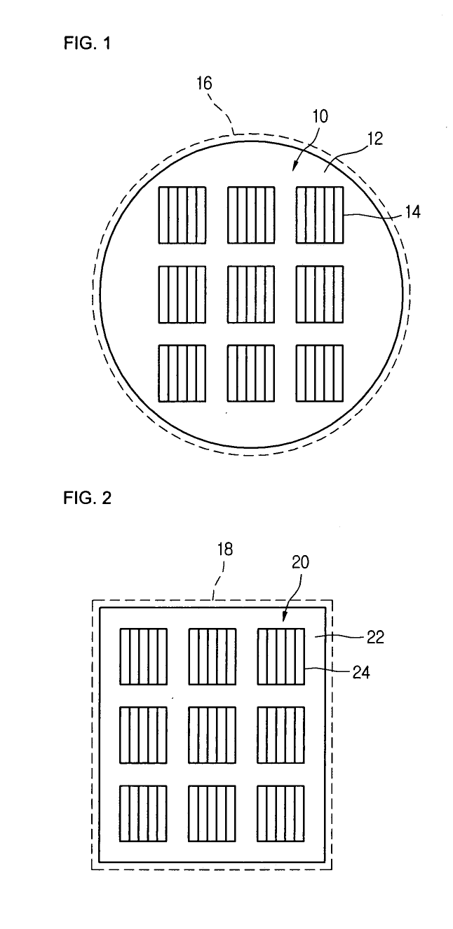

FIG. 1 is a plan view of a shadow mask according to one embodiment of the present invention.

Referring to FIG. 1, the shadow mask 10 includes a mask body 12 and openings 14 formed through the mask body 12.

The mask body 12 has a plate shape. In the embodiment, the mask body 12 has a shape corresponding to the shape of a chamber 16 to which the mask body 12 is coupled.

The mask body 12 of the shadow mask 10 has an outer side spaced apart from the inner side of the chamber 16 by a predetermined interval.

For example, the mask body 12 coupled to the cylindrical chamber 16 is spaced apart from the inner side of the chamber 16 by a predetermined interval, so that the mask body 12 has a disk shape.

A supporting body may be arranged in the inner side of the cylindrical chamber 16 in order to support the mask body 12. The supporting body may have a ring shape along the edge of the mask body 12.

FIG. 2 is a plan view of a shadow mask according to another embodiment of the present invention.

Referring to FIG. 2, the shadow mask 20 includes a mask body 22 and openings 24 formed through the mask body 22.

The mask body 22 has a plate shape. In the embodiment, the mask body 22 has a shape corresponding to the shape of a chamber 18 to which the mask body 22 is coupled.

The mask body 22 of the shadow mask 20 has an outer side spaced apart from the inner side of the chamber 18 by a predetermined interval.

For example, the mask body 22 coupled to the chamber 18 having a hexahedral shape is spaced apart from the inner side of the chamber 18 by a predetermined interval, so that the mask body 22 has a rectangular plate shape.

A supporting member may be arranged in the inner side of the cylindrical chamber 18 in order to support the mask body 22. The supporting member may have a rectangular band shape along the edge of the mask body 22.

In the above embodiments, the chamber 16 has a cylindrical shape, the chamber 18 has a hexahedral shape, the shadow mask 10 has a disk shape, and the shadow mask 20 has a rectangular plate shape. However, the shadow masks may have various shapes corresponding to the shapes of the chambers.

According to the above embodiments, since an interval between the outer side of the shadow mask 10 and the inner side of the chamber 16, and an interval between the outer side of the shadow mask 20 and the inner side of the chamber 18 are constantly formed, organic materials generated from the chambers 16 and 18 can be exhausted out of the chambers 16 and 18 through the openings 14 and 24 of the shadow masks 10 and 20.

Deposition Device

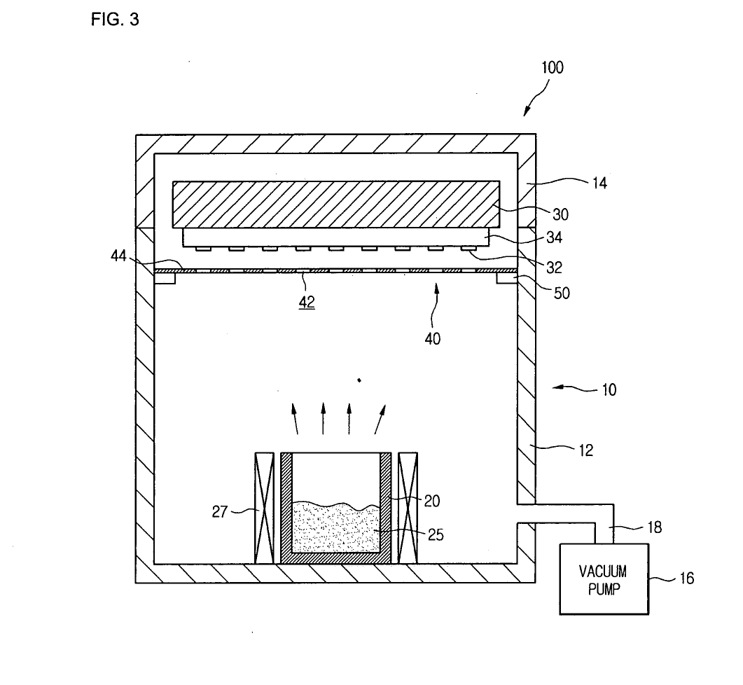

FIG. 3 is a sectional view of a deposition device according to one embodiment of the present invention.

Referring to FIG. 3, the deposition device 100 includes a chamber 10, a shadow mask 40, a deposition cell 20 and a supporting member 50.

The chamber 10 has a three-dimensional shape with a receiving space. For example, the chamber 10 has a polyhedral or cylindrical shape with a receiving space. In the embodiment, the chamber 10, for example, may have a cylindrical shape. However, the chamber 10 may also have a hexahedral or polyhedral shape.

The chamber 10, for example, having a cylindrical shape, includes a lower chamber body 12 and an upper chamber body 14 coupled to the lower chamber body 12. The upper chamber body 14 opens or closes the chamber 10. The chamber 10 is connected to a vacuum pump 16 that lowers internal pressure of the chamber below atmospheric pressure. The vacuum pump 16 is connected to the chamber 10 through a pipe 18.

The deposition cell 20 is arranged in the chamber 10. The deposition cell 20 may be arranged on the bottom surface of the chamber 10 and has a vessel shape. The deposition cell 20 has a receiving space, and sublimatable organic materials may be contained in the receiving space thereof.

A heating unit 27 is arranged outside the deposition cell 20 in order to sublimate organic materials contained in the deposition cell 20. The heating unit 27 may include an electric heater, and organic materials contained in the deposition cell 20 are sublimated by the heating unit 27.

A substrate fixing unit 30 is arranged on the chamber 10 to face the deposition cell 20. The substrate fixing unit 30 has a plate shape, and a substrate 34 is arranged under the substrate fixing unit 30. In the embodiment, the substrate 34, for example, has a rectangular parallelepiped plate shape. The substrate 34 having a rectangular parallelepiped plate shape, for example, can be applied to an OLED having an organic light generating layer 32.

The organic light generating layer 32 may include a hole injection layer, a hole transfer layer, an organic light emitting layer, an electron transfer layer and an electron injection layer formed on the substrate 34.

The substrate fixing unit 30, for example, absorbs and fixes the substrate 34 by using vacuum pressure. However, the substrate fixing unit 30 may also fix the substrate 34 by using static electricity.

The supporting member 50, for example, is arranged on the inner side of the lower chamber body 12. The supporting member 50, for example, may have a ring shape protruding from the inner side of the lower chamber body 12. However, plural supporting members 50 may be formed along the inner side of the lower chamber body 12 at a predetermined interval. The supporting member 50 supports the shadow mask 40. In addition, the supporting member 50 applies tensile force to the shadow mask 40 in order to prevent the shadow mask 40 from being bent.

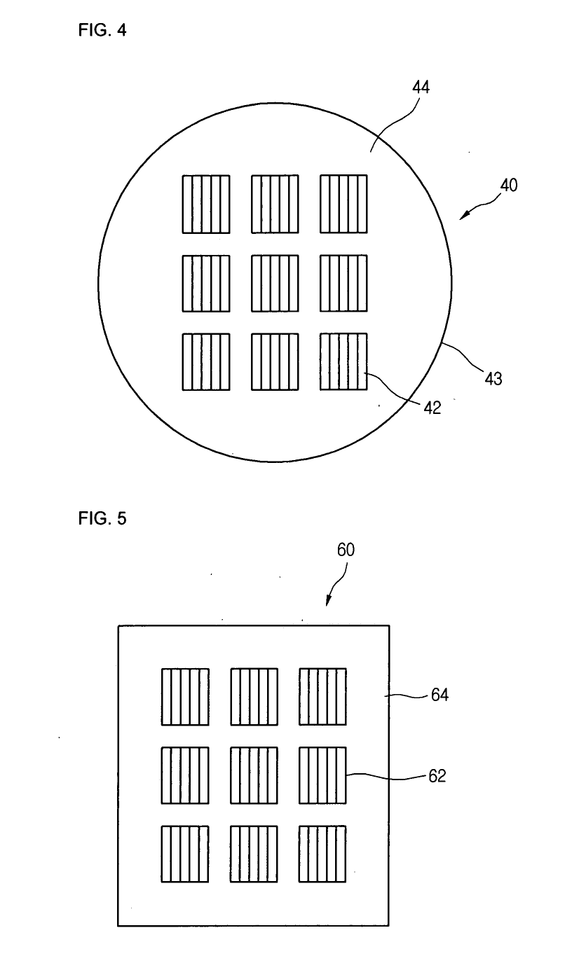

FIG. 4 is a plan view of the shadow mask shown in FIG. 2 according to further another embodiment of the present invention.

Referring to FIGS. 3 and 4, the shadow mask 40 includes a mask body 44 and openings 42 formed through the mask body 44.

The mask body 44 has a plate shape. In the embodiment, the mask body 44 has a shape corresponding to the shape of a chamber 10 to which the mask body 44 is coupled.

The mask body 44 of the shadow mask 40 has an outer side 43 spaced apart from the inner side of the chamber 10 by a predetermined interval.

For example, as the chamber 10 has a cylindrical shape, the mask body 44 coupled to the cylindrical chamber 10 is spaced apart from the inner side of the chamber 10 by a predetermined interval. Accordingly, the mask body 44 has a disk shape when viewed in a plan view.

The shadow mask 40 is arranged on the supporting member 50 disposed on the inner side of the chamber 10.

FIG. 5 is a plan view of the shadow mask according to still another embodiment of the present invention.

Referring to FIG. 5, the shadow mask 60 coupled to the chamber 10 includes a mask body 64 and openings 62 formed through the mask body 64.

The mask body 64 has a rectangular plate shape when viewed in a plan view. In the embodiment, the mask body 64 has a shape corresponding to the shape of the chamber 10 to which the mask body 64 is coupled.

The mask body 64 of the shadow mask 60 has an outer side spaced apart from the inner side of the chamber 10 by a predetermined interval.

As the chamber 10 has a hexahedral shape, the mask body 64 coupled to the chamber 10 is spaced apart from the inner side of the chamber 10 by a predetermined interval. Accordingly, the mask body 64 has a rectangular plate shape.

A supporting member 50 can be arranged in the hexahedral chamber 10 along the inner side of the chamber 10 in order to support the mask body 64.

In FIGS. 4 and 5, the chambers 10 have a cylindrical or hexahedral shape, the shadow mask 40 has a disk shape, and the shadow mask 60 has a rectangular plate shape. However, the shadow masks 40 and 60 may have various shapes corresponding to the shapes of the chambers.

Hereinafter, the operation of the deposition device according to the present invention will be described with reference to the accompanying drawings.

Referring to FIGS. 3 to 5, the upper chamber body 14 of the chamber 10 is opened, and then the deposition cell 20 having the deposition materials 25, e.g. sublimatable organic materials, is arranged in the chamber 10.

In the embodiment, sublimatable organic materials may include hole injection materials constituting a hole injection layer, hole transfer materials constituting a hole transfer layer, organic emitting materials constituting an organic light emitting layer, electron transfer materials constituting an electron transfer layer, and electron injection materials constituting an electron injection layer.

In a state in which the deposition cell 20 having the deposition materials 25 is arranged inside the chamber 10, the shadow mask 40 is mounted on the supporting member 50 arranged inside the chamber 10, in which the shadow mask 40 has the outer side spaced along the inner side of the chamber 10 by a predetermined interval.

The substrate 34 is fixed to the substrate fixing unit 30 in the chamber 10 in order to form an organic light generating layer on the pixel area 32. The substrate 34 is fixed to the substrate fixing unit 30 by vacuum pressure or static electricity.

After the substrate 34 is fixed to the substrate fixing unit 30, the upper chamber body 14 is coupled to the lower chamber body 12 so that the chamber 10 is sealed.

Then, vacuum pressure is formed inside the chamber 10 sealed by the operation of the vacuum pump 16, and the deposition materials 25 contained in the deposition cell 20 are sublimated by the heat generated by the heating unit 27.

The deposition materials sublimated from the deposition cell 20 move toward the upper portion of the chamber 10 to reach the shadow mask 40. Then, the deposition materials pass through the openings 42 of the shadow mask 40 to be deposited on the pixel area 32 formed on the substrate 34.

Since the outer side of the shadow mask 40 is spaced apart from the inner side of the chamber 10 by a predetermined interval, the organic materials sublimated from the deposition cell 20 are deposited on a location, e.g. the pixel area 32, designated on the substrate 34 through the openings formed in the shadow mask 40, without passing through between the shadow mask 40 and the inner side of the chamber 10.

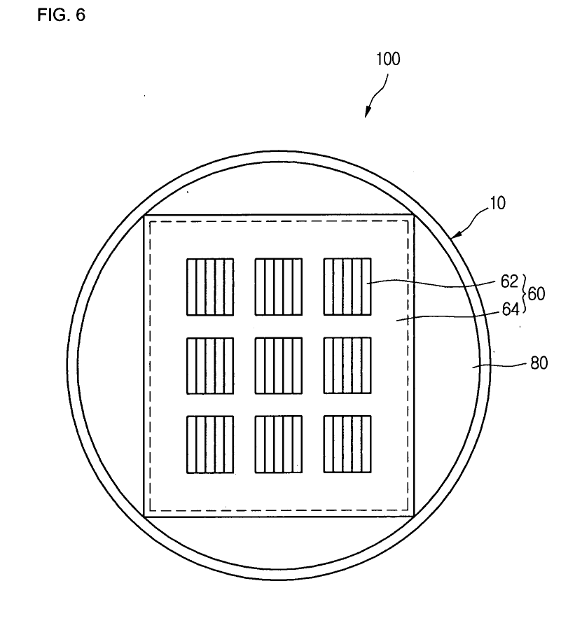

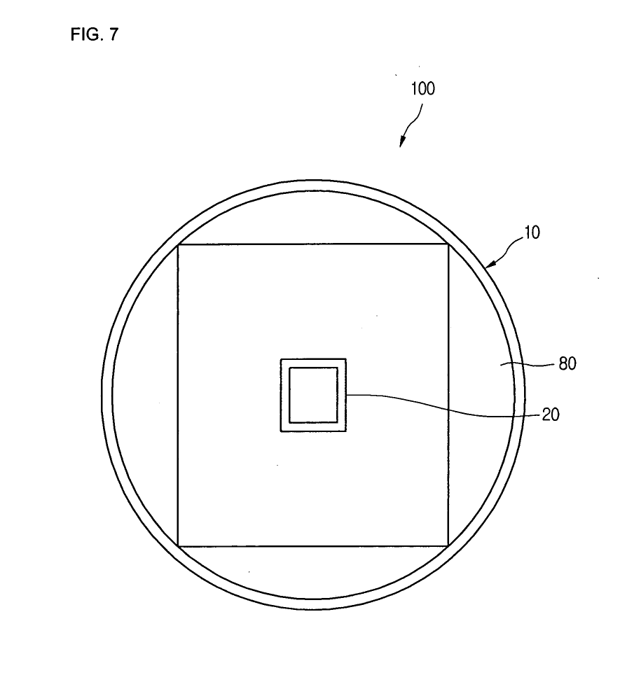

FIG. 6 is a plan view illustrating the chamber of the deposition device according to another embodiment of the present invention, and FIG. 7 is a plan view illustrating a state in which the shadow mask is coupled to the deposition device in FIG. 6.

Referring to FIG. 3, the deposition device 100 includes the chamber 10, the deposition cell 20 and a blocking member 80, and the shadow mask 60 shown in FIGS. 6 and 7 is arranged in the deposition device 100.

The chamber 10 has a three-dimensional shape with a receiving space. For example, the chamber 10 has a polyhedral or cylindrical shape with a receiving space. In the embodiment, the chamber 10, for example, may have a cylindrical shape.

As shown in FIG. 3, the chamber 10 having a cylindrical shape includes the lower chamber body 12 and the upper chamber body 14 coupled to the lower chamber body 12. The upper chamber body 14 opens or closes the chamber 10. The chamber 10 is connected to a vacuum pump 16 that lowers internal pressure of the chamber below atmospheric pressure. The vacuum pump 16 is connected to the chamber 10 through the pipe 18.

The deposition cell 20 is arranged in the chamber 10. The deposition cell 20 may be arranged on the bottom surface of the chamber 10 and has a vessel shape. The deposition cell 20 has a receiving space, and sublimatable organic materials are contained in the receiving space thereof.

The heating unit 27 is arranged outside the deposition cell 20 in order to sublimate the organic materials therein. The heating unit 27 may include an electric heater, and organic materials contained in the deposition cell 20 are sublimated by the heating unit 27.

The substrate fixing unit 30 is arranged on the chamber 10 to face the deposition cell 20. The substrate fixing unit 30 has a plate shape, and the substrate 34 is arranged under the substrate fixing unit 30. In the embodiment, the substrate 34, for example, has a rectangular parallelepiped plate shape. The substrate 34 having a rectangular parallelepiped plate shape, for example, can be applied to an OLED having an organic light generating layer 32.

The organic light generating layer 32 may include a hole injection layer, a hole transfer layer, an organic light emitting layer, an electron transfer layer and an electron injection layer formed on the substrate 34.

The substrate fixing unit 30, for example, absorbs and fixes the substrate 34 by using vacuum pressure. However, the substrate fixing unit 30 may also fix the substrate 34 by using static electricity.

Referring to FIG. 6, the shadow mask 60 includes the mask body 64 and the openings 62 formed through the mask body 64.

The mask body 64 has a plate shape when viewed in a plan view. In the embodiment, the mask body 64 has a rectangular plate shape when viewed in a plan view. That is, in the embodiment, the chamber 10 has a cylindrical shape and the shadow mask 60 has a rectangular plate shape.

As the chamber 10 has a cylindrical shape and the shadow mask 60 has a rectangular plate shape as described above, an empty spaced is formed between the outer side of the shadow mask 60 and the chamber 10. Therefore, the organic materials sublimated from the deposition cell 20 pass through between the outer side of the shadow mask 60 and the inner side of the chamber 10 as well as the openings 62 of the shadow mask 60, so that the chamber 10 and the substrate 34 may be contaminated.

The blocking member 80 prevents the organic materials from passing through between the inner side of the chamber 10 and the outer side of the shadow mask 60.

That is, the blocking member 80 partially overlaps with the edges of the shadow mask 60 so as to prevent the organic materials from passing through between the inner side of the chamber 10 and the outer side of the shadow mask 60. Accordingly, rectangle-shaped openings actually equal to those of the shadow mask 40 are formed in the chamber 10 by the blocking member 80 when viewed in a plan view.

Although the chamber 10 does not have the same shape as that of the shadow mask 60, the organic materials can be prevented from passing through between the chamber 10 and the shadow mask 60 by the blocking member 80.

In the embodiment, the blocking member 80 is arranged detachably from the chamber 10, and the part of a fixing member (not shown) is arranged on the blocking member 80 and the remaining part of the fixing member is coupled to the inner part of the chamber 10 in order to fix the blocking member 80 to the inner part of the chamber 10.

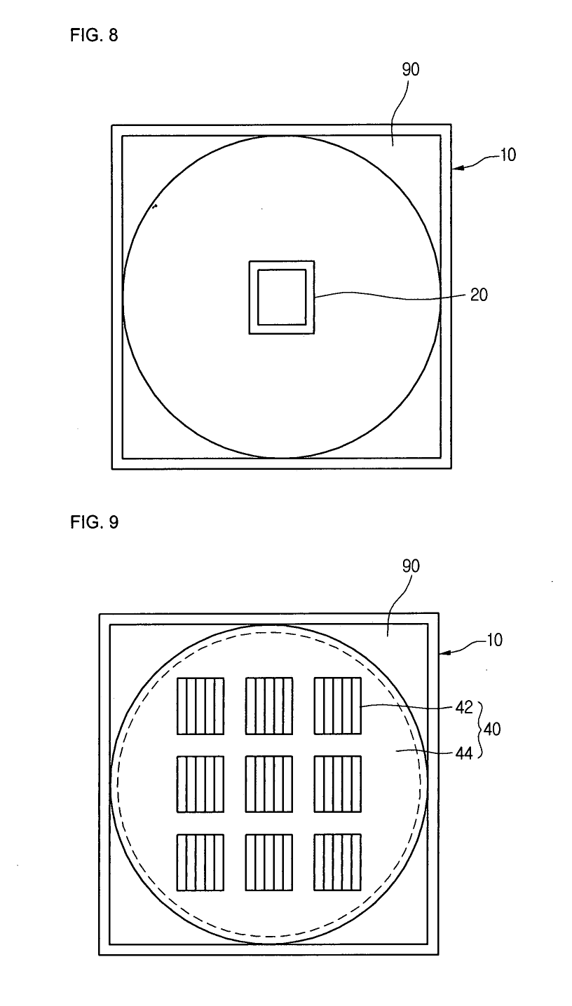

FIG. 8 is a plan view illustrating the chamber of the deposition device according to further another embodiment of the present invention, and FIG. 9 is a plan view illustrating a state in which the shadow mask is coupled to the deposition device in FIG. 8.

The deposition device 100 shown in FIG. 3 includes the chamber 10, the deposition cell 20 and a blocking member 90. The shadow mask 40 shown in FIGS. 8 and 9 is arranged on the deposition device 100 shown in FIG. 3.

The chamber 10 has a three-dimensional shape with a receiving space. For example, the chamber 10 has a hexahedral shape with a receiving space.

As shown in FIG. 3, the chamber 10 having a hexahedral shape includes the lower chamber body 12 and the upper chamber body 14 coupled to the lower chamber body 12. The upper chamber body 14 opens or closes the chamber 10. The chamber 10 is connected to a vacuum pump 16 that lowers internal pressure of the chamber 10 below atmospheric pressure. The vacuum pump 16 is connected to the chamber 10 through the pipe 18.

The deposition cell 20 is arranged in the chamber 10. The deposition cell 20 may be arranged on the bottom surface of the chamber 10 and has a vessel shape. The deposition cell 20 has a receiving space, and sublimatable organic materials are contained in the receiving space thereof.

The heating unit 27 is arranged outside the deposition cell 20 in order to sublimate the organic materials therein. The heating unit 27 may include an electric heater, and organic materials contained in the deposition cell 20 are sublimated by the heating unit 27.

The substrate fixing unit 30 is arranged on the chamber 10 to face the deposition cell 20. The substrate fixing unit 30 has a plate shape, and the substrate 34 is arranged under the substrate fixing unit 30. In the embodiment, the substrate 34, for example, has a rectangular parallelepiped plate shape. The substrate 34 having a rectangular parallelepiped plate shape, for example, can be applied to an OLED having an organic light generating layer 32.

The organic light generating layer 32 may include a hole injection layer, a hole transfer layer, an organic light emitting layer, an electron transfer layer and an electron injection layer formed on the substrate 34.

The substrate fixing unit 30, for example, absorbs and fixes the substrate 34 by using vacuum pressure. However, the substrate fixing unit 30 may also fix the substrate 34 by using static electricity.

Referring to FIG. 9, the shadow mask 40 includes the mask body 44 and the openings 42 formed through the mask body 44.

The mask body 44 has a plate shape when viewed in a plan view. In the embodiment, the mask body 44 has a disk shape when viewed in a plan view. That is, in the embodiment, the chamber 10 has a hexahedral shape and the shadow mask 40 has a disk shape.

As the chamber 10 has a hexahedral shape and the shadow mask 60 has a disk shape as described above, an empty spaced is formed between the outer side of the shadow mask 40 and the chamber 10. Therefore, the organic materials sublimated from the deposition cell 20 pass through between the outer side of the shadow mask 40 and the inner side of the chamber 10 as well as the openings 42 of the shadow mask 40, so that the chamber 10 and the substrate 34 may be contaminated.

The blocking member 90 prevents the organic materials from passing through between the inner side of the chamber 10 and the outer side of the shadow mask 40.

That is, the blocking member 90 partially overlaps with the edges of the shadow mask 40 so as to prevent the organic materials from passing through between the inner side of the chamber 10 and the outer side of the shadow mask 40. Accordingly, circular-shaped openings actually equal to those of the shadow mask 40 are formed in the chamber 10 by the blocking member 90 when viewed in a plan view.

Although the chamber 10 does not have the same shape as that of the shadow mask 40, the organic materials can be prevented from passing through between the chamber 10 and the shadow mask 40 by the blocking member 90.

In the embodiment, the blocking member 90 is arranged detachably from the chamber 10, and the part of a fixing member (not shown) is arranged on the blocking member 90 and the remaining part of the fixing member is coupled to the inner part of the chamber 10 in order to fix the blocking member 90 to the inner part of the chamber 10.

According to the present invention as described above, deposition materials sublimated from a deposition cell are prevented from passing through the shadow mask, except for the openings of the shadow mask, so that the inside of a chamber can be prevented from being contaminated, thereby improving workability of a thin film deposition device. In addition, deposition materials attached to the inside of the chamber can be prevented from being separated from the chamber, so the deposition materials cannot serve as particles.

Although embodiments have been described with reference to a number of illustrative embodiments thereof, it should be understood that numerous other modifications and embodiments can be devised by those skilled in the art that will fall within the spirit and scope of the principles of this disclosure.

What is claimed is:

1. A shadow mask comprising:
a mask body that has an outer side spaced along an inner side of a chamber by a predetermined interval; and
a plurality of openings disposed through the mask body.

2. The shadow mask as claimed in claim 1, wherein the chamber has a cylindrical shape and the mask body has a disk shape.

3. The shadow mask as claimed in claim 1, wherein the chamber has a hexahedral shape and the mask body has a rectangular plate shape.

4. A deposition device comprising:
a chamber;
a shadow mask that divides the chamber into an upper portion and a lower portion, and has a plurality of openings through which the upper portion is communicated with the lower portion;
a deposition cell disposed on the lower portion of the chamber, in which the deposition cell contains deposition materials; and
a supporting member disposed along an inner side of the chamber to support edges of the shadow mask.

5. The deposition device as claimed in claim 4, wherein the chamber has a cylindrical shape and the shadow mask has a disk shape.

6. The deposition device as claimed in claim 4, wherein the chamber has a hexahedral shape and the shadow mask has a rectangular plate shape.

7. The deposition device as claimed in claim 4, wherein the supporting member protrudes in a closed loop shape along the inner side of the chamber.

8. The deposition device as claimed in claim 4, wherein the supporting member includes a protrusion that protrudes from the inner side of the chamber by a predetermined length.

9. The deposition device as claimed in claim 4, wherein a substrate fixing unit is disposed in an upper portion of the chamber in order to fix a substrate.

10. A deposition device comprising:
a shadow mask that has a plurality of openings;
a chamber that has the shadow mask therein;
a deposition cell disposed on a lower portion of the chamber, in which the deposition cell contains deposition materials; and
a blocking member interposed between an inner side of the chamber and an outer side of the shadow mask so as to prevent the deposition materials from passing through between the inner side of the chamber and the outer side of the shadow mask.

11. The deposition device as claimed in claim 10, wherein the shadow mask has a rectangular plate shape and the chamber has a cylindrical shape.

12. The deposition device as claimed in claim 11, wherein the blocking member blocks a space between a side of the shadow mask and a curvature surface of the chamber.

13. The deposition device as claimed in claim 10, wherein the shadow mask has a disk shape and the chamber has a hexahedral shape.

14. The deposition device as claimed in claim 13, wherein the blocking member blocks a space between a curvature surface of the shadow mask and the inner side of the chamber.

15. The deposition device as claimed in claim 10, wherein the blocking member further comprises a stretching unit disposed on the inner side of the chamber so as to apply tension to the shadow mask in order to prevent the shadow mask from being bent.

16. The deposition device as claimed in claim 10, wherein the blocking member overlaps with edges of the shadow mask.

17. The deposition device as claimed in claim 10, wherein a heating unit is disposed around the deposition cell in order to heat the deposition cell.

18. The deposition device as claimed in claim 17, wherein the heating unit includes an electric heater.

19. The deposition device as claimed in claim 10, wherein a supporting member is disposed on the inner side of the chamber in order to support the blocking member.
